(19) United States
(12) Patent Application Publication
(10) Pub. No.: US 2010/0082478 A1
(43) Pub. Date: Apr. 1, 2010

(54) APPARATUS & METHODS FOR DIGITAL CONTENT DISTRIBUTION

(75) Inventors: Minne Van Der Veen, Eindhoven (NL); Aweke Negash Lemma, Eindhoven (NL); Stefan Katzenbeisser, Wien (AT); Mehmet Utku Celik, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/530,561

(22) PCT Filed: Mar. 10, 2008
(86) PCT No.: PCT/IB08/50868

§ 371 Date: Sep. 9, 2009

(30) Foreign Application Priority Data
Mar. 16, 2007 (EP) 07104317.8

(51) Int. Cl. G06Q 40/00; H04L 9/08; H04L 9/32

(52) U.S. Cl. 705/39; 713/153; 380/283; 713/176

(57) ABSTRACT

The present invention relates to methods and apparatus for digital content distribution. A method of transferring digital content from a first entity (60) to a second entity (70) includes the steps of: a transfer control entity (50) transmitting a transmission key (K_{A}) to the first entity, the first entity storing content data comprising digital content embedded with a first watermark (W_{A}). The first entity applies the transmission key to the content data to remove the first watermark from the digital content and encrypt the digital content. The first entity transmits the encrypted digital content (C_{X}) to the second entity. The transfer control entity transmits a receive key (K_{B}) to the second entity and the second entity applies the receive key to the encrypted digital content to generate decrypted data comprising the decrypted digital content embedded with a second watermark (W_{B}).

### FIELD OF THE INVENTION

The present invention relates to methods and apparatus for transferring digital content between different entities, for digital content distribution. Embodiments of the present invention are particularly suitable for, but not limited to, peer-to-peer file sharing.

### BACKGROUND OF THE INVENTION

Digital content, such as audio, video, text, data, multimedia files and the like, can be easily shared or distributed e.g. over a computer network. A large number of electronic download and multimedia file sharing systems have been utilized. Often, in early examples, the content was freely shared. More recently, a number of commercial and legal multimedia file distribution services exist. It is expected that such download of services will dramatically expand in the future, particularly as the ever increasing bandwidth capacity facilitates the easy downloading and sharing of video content. It is anticipated that legalized peer-to-peer file sharing will also increase in popularity, with potentially peer-to-peer file sharing being increasingly used on wireless mobile devices, and not just on static computers.

DRM (Digital Rights Management) technology has been developed with a view to restricting the illicit sharing or distribution of such content.

DRM restrictions are typically implemented in two ways. The first is “containment” where the content is encrypted, so that only an authorized user can access it. The second is “marking” where a watermark is embedded within the content. The watermark can act as a signal to a terminal that the content is properly protected e.g. to prevent the terminal generating an illicit copy of the content.

A so called “light-weight” DRM system can be implemented by embedding a forensic watermark in the digital content, when the digital content is sold (or otherwise transferred) to a consumer. The forensic watermark is a watermark related to the identity of the consumer e.g. the mark may contain a user ID corresponding to the user. Thus, each consumer would possess a copy of the content embedded with a different respective watermark. If the content is distributed (e.g. on an illegal peer-to-peer file sharing system), then the embedded watermark can be used to determine the identity of the consumer who has leaked or illegally distributed the content.

FIG. 1 illustrates a schematic diagram of a client-server architecture for distributing digital media content, which makes use of such forensic watermarks. The content is initially stored on a content server 10, which can be viewed as the content owner. A user 12, who owns or has access to a consumer device 14 suitable for playing the content (or storing the content, and downloading the stored content to a player) accesses a download website 18 (e.g. a download shop). The user 12 transmits identity information to the website 18. The website 18 subsequently sends a signal indicative of the identity of the user to a watermark embedding system 20. The watermark embedding system utilizes the identity of the user to generate a forensic watermark specific to that user, which is subsequently embedded into the digital content. The watermark embedded digital content can then be downloaded to the consumer device (i.e. the “client”) over the Internet 22. If the user 12 should subsequently illegally distribute the digital content, then the distributed content can be detected as being from the particular user 12 from the user-specific forensic watermark.

Although the use of forensic watermarks in server-client is known, it is not trivial to translate these principles to legalized file sharing systems, whether static, wireless or intelligent.

For example, FIG. 2 shows a similar architecture as FIG. 1, but with the addition of another user 32, who possesses a relevant device 34 suitable for storing or playing digital content. Assume that user 12 has already downloaded a copy of the digital content, with a forensic watermark W_{A} embedded, corresponding to the identity of user 12. If user 32 wishes to obtain a copy of the digital content from user 12 (i.e. if a copy of the digital content is transferred from device 14 to device 34), then it will be appreciated that a forensic watermark relating to user 32 (e.g. W_{B}) should be embedded within the digital content.

Otherwise, if user 32 should subsequently illegally distribute a copy of the digital content, then it would not be possible to ascertain from the distributed content the identity of the distributor (user 32).

One way of addressing this problem would be to embed the watermark W_{B} for user 32 into the digital content, such that the digital content is embedded with two watermarks (W_{A} & W_{B}). In such a system, each time the digital content was transferred to another user, an additional watermark would be embedded within the content. A disadvantage of this approach is that the addition of more than one watermark could lead to a degradation in the quality of the digital content e.g. a degradation in video image quality or audio quality. Additionally, as successive watermarks are added, there is likely to be collision between the watermarks, potentially rendering the watermarks undetectable or leading to ambiguous detection of the watermarks i.e. effectively rendering them useless.

An alternative scheme for file sharing between users (e.g. peers) is to link the watermark of the content to a particular user by using a database stored on/by a Trusted Third Party (TTP). Each legal copy of the digital content includes a unique watermark. The TTP stores a database indicating the particular consumer/user associated with each watermark. In such a scheme, when a copy of the digital content is moved from consumer device 14 to consumer device 34, instead of updating the watermark, the database entry of the relevant watermark at the Trusted Third Party is updated to indicate that the relevant watermark now relates to content possessed by user 32, rather than user 12. Whilst this system does overcome the disadvantages of collision between different watermarks, and is unlikely to result in degradation of the quality of the digital content, it is open to abuse.

For example, user 12 could arrange to copy the digital content (or retain a copy of the digital content on his own device), as well as provide a copy of the digital content to user 32. The database of the TTP would be updated to reflect that the watermark embedded in the digital content now related to user 32, and so such an approach would not be able to detect if user 12 illegally distributed the copy of the digital content stored on consumer device 14.

### OBJECT AND SUMMARY OF THE INVENTION

It is an aim of embodiments of the present invention to address one or more problems of the prior art, whether identified herein or otherwise. It is an aim of particular embodiments of the present invention to provide an improved system, for transferring digital content between different entities, such as may be used in peer-to-peer file sharing.

In a first aspect, the present invention provides a method of transferring digital content from a first entity to a second entity, comprising the steps of:
a transfer control entity transmitting a transmission key to a first entity, the first entity storing content data comprising digital content embedded with a first watermark;
the first entity applying the transmission key to the content data to remove the first watermark from the digital content and encrypt the digital content;
the first entity transmitting the encrypted digital content to a second entity;
the transfer control entity transmitting a receive key to the second entity; and
the second entity applying the receive key to the encrypted digital content to generate decrypted data comprising the decrypted digital content embedded with a second watermark.

Utilizing such a method allows the digital content to be securely distributed. The entity possessing the digital content will either have the digital content in an encrypted form (i.e. it is not readily readable), or in a form in which the digital content is decrypted but embedded with a relevant watermark. Such a watermark can be a forensic watermark, indicative of the identity of the entity possessing the digital content. Thus, such a method facilitates the peer-to-peer file sharing of digital content, whilst both allowing the secure updating of the relevant watermark, and minimizing the likelihood of signal degradation due to watermark collision (as can occur in prior art techniques).

The method may further comprise the step of performing an authenticity check of the encrypted digital content, to determine whether the digital content has been modified.

The method may further comprise the step of the second entity transmitting a payment to the transfer control entity.

The method may further comprise the step of the transfer control entity transmitting a payment to the first entity.

The method may comprise:
the transfer control entity transmitting a plurality of transmission keys to the first entity;
the first entity storing said plurality of transmission keys in a memory; and
the first entity selecting one of said stored transmission keys to apply to said content data to remove said first watermark from the digital content and encrypt the digital content.

Said step of selecting one of said transmitting keys may be a random selection, the method further comprising:
the first entity transmitting identification data indicative of the identify of the selected key to at least one of the second entity and the transfer control entity.

The method may further comprise:
the transfer control entity transmitting selection data to said first entity; and
the first entity selecting said one of said stored transmission keys based upon the selection data.

The method may comprise:
the transfer control entity transmitting a plurality of receive keys to the second entity;
the second entity storing said plurality of receive keys in a memory; and
the second entity selecting one of said stored receive keys, to apply to the encrypted digital content to generate the decrypted data comprising the decrypted digital content embedded with the second watermark, based upon identification data received from at least one of the transfer control entity and the first entity.

The method may comprise the steps of:
a first entity receiving a transmission key from a transfer control entity, the first entity storing content data comprising digital content embedded with a first watermark;
the first entity applying the transmission key to the content data to remove the first watermark from the digital content and encrypt the digital content; and
the first entity transmitting the encrypted digital content to a second entity.

Said transmission key may be arranged to simultaneously remove the watermark and encrypt the digital content, when applied to said data file.

In a second aspect, the present invention provides a method of receiving digital content, comprising the steps of:
a second entity receiving encrypted digital content from a first entity;
the second entity receiving a receive key from a transfer control entity; and
the second entity applying the receive key to the encrypted digital content to generate decrypted data comprising the decrypted digital content embedded with a second watermark.

Said receive key may be arranged to simultaneously decrypt the encrypted digital content and embed the second watermark in said digital content, when applied to the encrypted digital content.

In a third aspect, the present invention provides a method for controlling the transfer of digital content, comprising the steps of:
a transfer control entity transmitting a transmission key to a first entity, the transmission key being for application to content data comprising digital content embedded with a first watermark, for removing the first watermark from the digital content and encrypting the digital content.

The method may further comprise the steps of:
the transfer control entity storing information indicative of the first watermark in a memory; and
the transfer control entity generating the transmission key using said stored information.

The encrypted digital content may be encrypted by a mask.

Said encrypted digital content may be encrypted using random noise.

Said encrypted digital content may be encrypted using a one time pad.

In a fourth aspect, the present invention provides a carrier medium carrying computer readable program code configured to cause a computer to carry out a method as described above.

In a fifth aspect, the present invention provides an apparatus comprising means arranged to perform the method as described above.

In a sixth aspect, the present invention provides a computer apparatus comprising:
a program memory containing processor readable instructions; and
a processor configured to read and execute instructions stored in said program memory,
wherein said processor readable instructions comprise instructions configured to cause the computer to carry out a method as described above.

In a seventh aspect, the present invention provides a transmission key for application to content data comprising digital content embedded with a first watermark, the transmission key being arranged to remove the first watermark and encrypt the digital content when applied to the content data.

Said key may be arranged to simultaneously remove the watermark and encrypt the digital content, when applied to said content data.

In an eighth aspect, the present invention provides a carrier medium storing the transmission key in computer readable code.

### BRIEF DESCRIPTION OF THE DRAWINGS

An embodiment of the present invention will now be described, by way of example only, with reference to the accompanying drawings, in which:

FIG. 1 is a schematic diagram of a client-server architecture for distributing a data file including digital content;

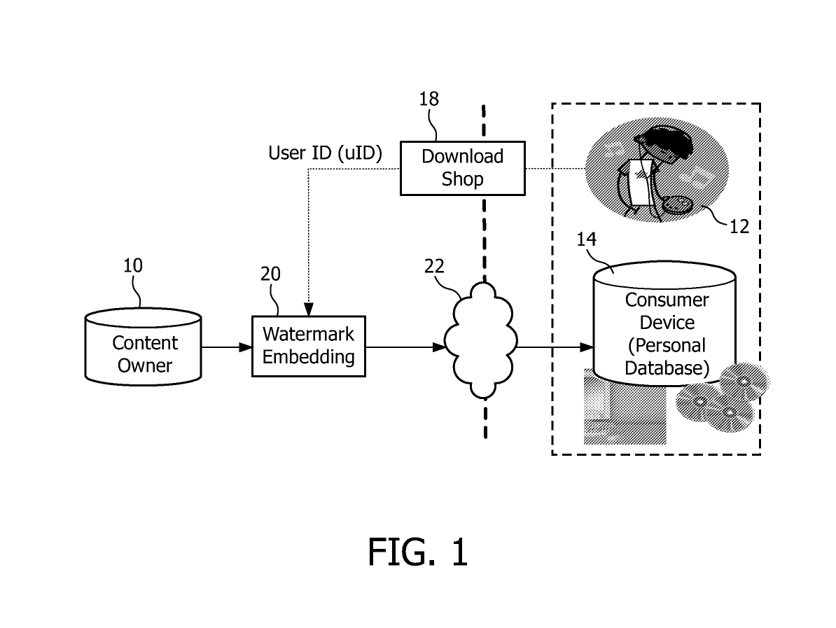

FIG. 2 is a modified version of FIG. 1, illustrating an architecture for transferring the data file from a first client to a second client i.e. peer-to-peer file sharing;

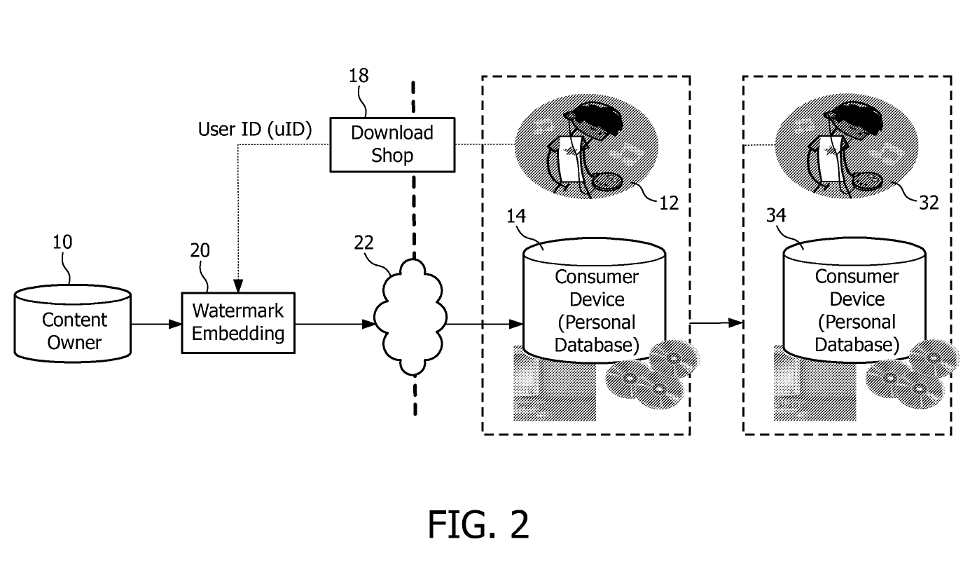

FIG. 3 is a schematic diagram, illustrating the transfer of digital content between two entities, in accordance with an embodiment of the present invention; and

FIG. 4 is a schematic diagram illustrating the transfer of digital content between three separate entities, in accordance with an embodiment of the present invention.

### DETAILED DESCRIPTION OF THE EMBODIMENTS

Embodiments of the present invention facilitate legalized peer-to-peer file sharing, whilst maintaining Digital Rights Management, by ensuring that the digital content is either in an encrypted form (i.e. it is masked, so it can not be read), or is in a form in which the digital content is embedded with a forensic watermark. The technique makes use of a TTP (Trusted Third Party) to provide an appropriate transmission key for encrypting the digital content/removing the original forensic watermark.

Further, the TTP also supplies a second (receive) key for decrypting the digital content and embed another forensic watermark (indicative of the peer having received the encrypted digital content). To prevent hacking, each key is arranged to perform its operation in a single process e.g. the transmission key is arranged to both encrypt the digital content and remove the first watermark from the digital content, in a single operation e.g. to perform both actions simultaneously.

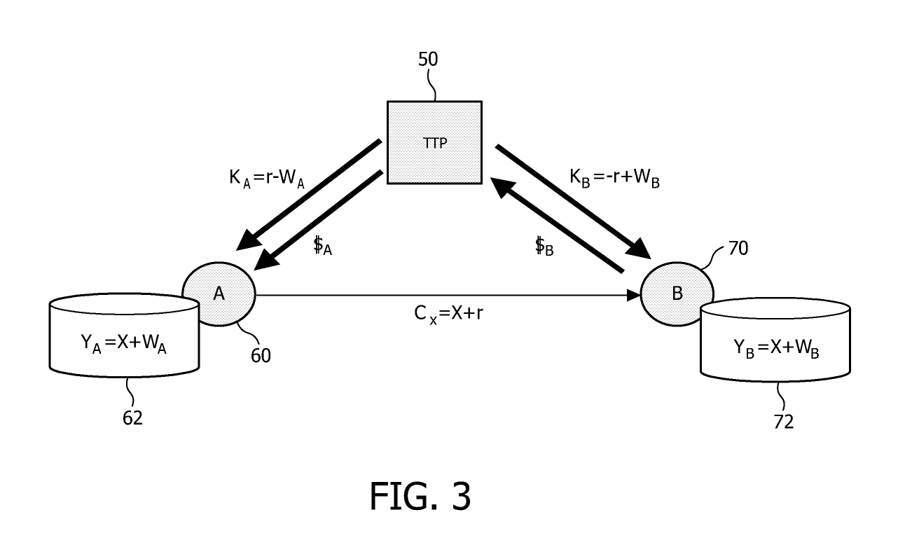

A preferred embodiment of the present invention will now be described with reference to FIG. 3. The preferred embodiment will be described with reference to a Trusted Third Party 50 and two peers (peer A & peer B) 60, 70. It should be realized that in most implementations the TTP and both peers will each be implemented as computers, computational devices, or other automated communication and data storage devices. Each computer/computational device would comprise a program memory storing processor readable instructions, and a processor configured to read and execute the stored instructions, so as to cause the computer to carry out the relevant method steps. Typically, the digital content will take the form of audio, video, text, data or multimedia files or the like. In most instances (but not all), such data would be stored in a data file. The device/computer would typically be arranged to display or play the digital content, or store the digital content for download to a suitable display device or playing device, or both. For example, in the case of an audio file, a computer could be arranged to both play the audio file, and also to store the audio file for download to an MP3 player.

The TTP and peers A & B are each separate, discrete entities e.g. peer A is a first entity, peer B is a second entity, and the TTP is the transfer control entity (as it allows the secure transfer of digital content from peer A to peer B). Each entity 50, 60, 70 can communicate with the other two entities. For example, the transfer control entity (TTP 50) can be a server, connected to one or more communications networks. Each network can comprise a computer network, such as the Internet or an intranet. The first and second entities (peers A & B) can be personal computers (or mobile devices such as mobile phones, media players, Personal Digital Assistants etc), also connectable to the same communications network, (e.g. the Internet) as the transfer control entity. Thus, both the first and second entities can communicate with the transfer control entity over one or more communications networks. The first entity and the second entity can also communicate (e.g. send digital content and requests for digital content) to each other, over a communications link. This could be a communications link over a communications network, or it could be a direct link between the two entities such as a wireless link (e.g. a Bluetooth link or an infrared link) or a wired link (e.g. a cable connecting the two entities together).

As shown in FIG. 3, peer A 60 includes a memory 62, and peer B 70 includes a memory 72. The memories 62, 72 are arranged to store the relevant digital content, as well as the relevant keys for encrypting/decrypting the digital content.

Initially, peer A 60 stores content data as a data file comprising digital content embedded with a first watermark. The first watermark is a forensic watermark indicative of, or at least linked to, the identity of peer A. For example, the watermark could indicate the name of the owner, or a user, of the computational device forming peer A, or could be the MAC (Media Access Control) address of the network adaptor of peer A.

The watermark can be an additive watermark W_{A}, in which case the digital content can be expressed in a simplistic form as:

Y_{A}=X+W_{A} [1]

where X is the unwatermarked digital content and Y_{A} is the digital content embedded with the first watermarked W_{A}.

In this particular example, it is assumed that the digital content Y_{A} has been obtained from the TTP 50, such that TTP 50 has knowledge of the relevant watermark W_{A} e.g. peer A may have purchased digital content in the form of multimedia data from the TTP 50. Otherwise, the TTP 50 would either, so as to perform the subsequent steps, obtain knowledge of the relative watermark W_{A} (so as to generate the relevant transmission key), or obtain the relevant key (or data for generating the key) from a further entity.

Peer A receives a notification that peer B would like to obtain a copy of the digital content. This notification could be sent directly from peer B to peer A, or could be sent via another entity (including TTP 50).

Peer A 60 receives a transmission key K_{A} from the TTP 50. Transmission of the transmission key from TTP 50 could be in response to a request from peer A for TTP 50 to provide a transmission key. Alternatively, if peer A has been notified that peer B would like to obtain a copy of the digital content by a notification transmitted via TTP 50, then TTP 50 could automatically provide the transmission key to peer A e.g. at the same time as transmitting the notification to peer A, or a predetermined time period thereafter.

The transmission key K_{A} is arranged to simultaneously encrypt the digital content and remove the first watermark W_{A} when applied to the watermarked digital content Y_{A}. For example, assuming that the watermark is an additive watermark, with the embedded digital content having the form expressed in equation [1], then a suitable transmission key K_{A} could be expressed by:

K_{A}=r−W_{A} [2]

where r represents the function used to encrypt the digital content.

For example, r could represent any masking function, which when applied to the digital content, prevents the reading of the resulting marked digital content. For example, if the digital content represents an audio stream or signal, then the encryption r could represent any signal to mask the audio signal, and prevent a listener from hearing (or at least hearing clearly) the desired digital content when played. Preferably, the digital content is encrypted using random noise i.e. r is a random noise function, so as to inhibit the ability of an attack to remove the encryption/masking of the digital content. Most preferably, the digital content is encrypted using a one time pad (OTP). An OTP is an encryption algorithm where the plain text (e.g. the audio signal) is combined with a random key or “pad” that is as long as the plain text, and used only once. If the random key (r) is truly random, never re-used, and kept secret, the OTP is theoretically unbreakable.

An example of a suitable marking function (together with a description of how the function can be removed by a suitable key) is described within the article “Copyright Protection for MPEG-2 Compressed Broadcast Video” by S Emmanuel & M Kankanhalli,

ICME 2001, IEEE International Conference on Multimedia and Expo, pp. 273-276. The article describes examples of how video files can be encrypted (i.e. masked) in either the spatial domain or the compressed domain. The content of that article is incorporated herein by reference. The article describes how an opaque mask frame can be added on to the original compressed video, frame by frame, by a broadcaster. A subscriber can remove the mask and also embed a robust, invisible watermark. Such a technique as described in that document can be utilized in embodiments of the present invention (e.g. to encrypt video or multi-media signals), but with the additional concept that the key used to encrypt/mask the digital content is also arranged to remove a watermark (which can be robust and/or invisible) embedded within the digital content. This removal of the embedded watermark is important, as it facilitates secure peer to peer sharing of digital content.

In preparation for transmission of the digital content to peer B, peer A applies transmission key K_{A} to the digital content Y_{A}. The transmission key, when applied to the digital content including the embedded first watermark W_{A}, acts to both remove the watermark W_{A} and encrypt the digital content. For example, assuming that the watermark is an additive watermark as illustrated in equation [1] and the key takes the form indicated in equation [2], then addition of the key to the digital content embedded with the watermark W_{A} will result in generation of a cipher text (i.e. the encrypted digital content) C_{X} as follows:

C_{X}=Y_{A}+K_{A}=X+W_{A}+r−W_{A} [3]

i.e.

C_{X}=X+r [4]

In other words, in this simple example, the encrypted digital content takes the form of the original digital content X (without any watermarks embedded), masked by a random noise signal r. The random noise signal will typically, but need not be, the same length as the original digital content e.g. if it is a signal divided into frames, then the random noise signal r will typically have the same number of frames as the original digital content. Alternatively, the signal r could be shorter than the original digital content, e.g. r might only be applied to a predetermined selection of the frames of the digital content.

The encrypted digital content is then transmitted from peer A to peer B.

The encrypted digital content may be further encoded or encrypted, for transmission. If such further encryption or encoding is performed, then the signal is decrypted or de-encoded back to C_{X} when received at peer B 70.

The encrypted digital content C_{X} is received by peer B. The TTP 50 also transmits a receive key K_{B} to peer B 70.

The TTP 50 could transmit the receive key K_{B} to peer B 70 at any time, including following the receipt of any one of various notifications. For example, the TTP 50 could arrange to transmit the receive key K_{B} to peer B 70, at the same time, or around the same time, as transmitting the transmission key K_{A} to peer A 60. Alternatively, TTP 50 could transmit the receive key K_{B} to peer B 70 after receiving a notification from peer A that encrypted digital content C_{X} has been transmitted to peer B, and/or after receiving a notification from peer B that the encrypted digital content has been received.

The receive key is arranged to decrypt (e.g. unmask) the encrypted (masked) digital content, and also apply a second watermark W_{B} to the digital content. For example, the receive key K_{B} could be of the form:

K_{B}=−r+W_{B} [5]

Peer B 70 applies the receive key K_{B} to the encrypted digital content C_{X}, to decrypt the content C_{X} and form decrypted data Y_{B}, which is the digital content embedded with the second, forensic watermark, W_{B}.

In other words, assuming a simple additive watermark and additive random noise encryption as indicated above, then:

Y_{B}=C_{X}+K_{B}=X+r−r+W_{B} [6]

i.e.

Y_{B}=X+W_{B} [7]

The resulting decrypted data (i.e. the digital content embedded with the second watermark) can be stored in memory 72 of peer B 70 as a data file.

Preferably a corresponding payment model is associated with the transfer of digital content between the two entities (peers A, B). For example, preferably peer A 60 receives a payment (SA) associated with transmitting the digital content e.g. upon notification that the relevant digital content has been successfully received (and/or decrypted) by peer B. For example, peer B could signal the TTP that the digital content has been successfully received, and TTP could then transmit payment to peer A. Such a financial transaction would provide an incentive for peer A to share digital content.

Peer B would, in most implementations, pay for the digital content e.g.

transmit payment to the digital content. Such a payment by peer B could be transmitted to the TTP at the same time that peer B requests a copy of the digital content stored by peer A, or after receipt of the encrypted digital content (C_{X}) from peer A. For example, the TTP could await payment from peer B, before transmitting to peer B the receive key K_{B}.

It should be noted that the payment need not relate directly to money, but could relate to credit or virtual money. Equally, it should be noted that the trusted third party (TTP) associated with the payment need not necessarily be the same TTP 50 associated with the transmission of the transmission and receive keys (K_{A} & K_{B}), although in most implementations either a single TTP would be utilized, or any TTP's would be in communication with each other.

It should be appreciated that the above embodiment is described by way of example only, and that various alternatives will be apparent to the skilled persons falling within the scope of the appended claims.

For example, the method has been described with respect to additive forensic watermarks. It should be appreciated that forensic watermarks need not be utilized. Equally, it should be appreciated that the watermarks need not be additive watermarks—the invention could be implemented using any watermark scheme (e.g. multiplicative or other) that allows the watermark to be embedded, and subsequently removed.

Further, the above method describes how digital content may be embedded with a watermark, the content subsequently encrypted (using the transmission key), and then decrypted (using the receive key), to generate decrypted data comprising the decrypted digital content embedded with the second watermark. It should be appreciated that such operations need not be applicable to all of the content. For example, within the content data stored by the first entity, only a portion of the relevant total digital content may be embedded with the first watermark. Equally, the first entity may apply the transmission key to the content data so as to only encrypt a portion of the digital content. Similarly, the second entity may apply the receive key to the encrypted digital content to generate decrypted data, only a portion of which is embedded with a second watermark.

For example, the article by A. Lemma, S. Katzenbeisser, M. Celik, M. van derVeen, “Secure Embedding Through Partial Encryption”, International Workshop on Digital Watermarking, 2006, Springer Lecture Notes in Computer Science vol. 4238, pp. 433-445, describes examples of how perceptually significant features of data can be selected, and only those features encrypted. Similarly, embodiments of the present invention may be implemented by only encrypting portions of the digital content, such as the perceptually significant features. The content of that article is incorporated herein by reference. The article describes how the MASK watermarking scheme can be utilized in joint decryption and watermarking In MASK, a watermark is embedded by modifying the envelope of the host signal. Also, the article describes how the general methodology of joint watermarking and decryption can be applied to MPEG-2 compressed streams. Embodiments of the present invention may utilize such a methodology applied to video streams, such as MPEG-2.

Within the preferred embodiment, the TTP 50 (i.e. the transfer control entity) is described as transmitting an appropriate transmission key and an appropriate receive key to peer A and peer B respectively, at appropriate times. It should be appreciated that the TTP 50 need not transmit individual keys to the relevant peers. For example, the TTP 50 could transmit a large number of different transmission keys to peer A, and/or a large number of different receive keys to peer B. Peer A could then store the set of transmission keys in memory 62, and peer B could store the set of receive keys in memory 72.

When the digital content is being encrypted by peer A for transmission to peer B, then the relevant transmission key could be selected by peer A from the stored set, at random. Alternatively, peer A could select the relevant transmission key to use to encrypt the digital content for transmission, based upon selection data transmitted from the TTP 50.

Upon receipt of encrypted digital content at peer B, then peer B could select the corresponding receive key necessary to decrypt the digital content from the set of stored receive keys. This selection by peer B could be based upon identification data received either from the TTP, or peer A.

Such an implementation, using stored transmission and/or receive keys at the peers A, B, would minimize the bandwidth required for, or completely negate the need for, a transmission channel (e.g. an online connection) to the TTP over the time period in which the digital content is being shared.

The method can include one or more authenticity checks upon the digital content, to determine whether the digital content has been modified. Peer A could theoretically modify the digital content Y_{A} without (significantly) affecting the perceptual quality of the digital content. For example, minor changes might be made to an audio track, without significantly affecting the quality of the audio track. Modification of the digital content typically also results in modification of any embedded watermarks i.e. when modifying Y_{A}, not only would X (the original, unwatermarked digital content) be modified, but also W_{A} (the embedded watermark). Such a modification would then prevent the transmission key K_{A} removing the watermark W_{A} when applied to the watermark digital content.

Accordingly, the method can therefore include an authenticity check being performed upon the digital content with the transfer of digital content being prevented, or not paid for, if the check fails. For example, payment might only be transmitted to peer A if the authenticity check is passed (i.e. it is verified that the digital content has not been modified).

The authenticity check could be performed upon the watermark embedded digital content (Y_{A}), the encrypted digital content (C_{X}), or a portion of either, or a hash derived therefrom. Typically the TTP 50 would perform the authenticity check. For example, a hash could be computed of the encrypted digital content, and transmitted to the TTP 50, which then performs the authenticity check. The TTP 50 could then check the hash received from peer A (or peer B) against the anticipated hash.

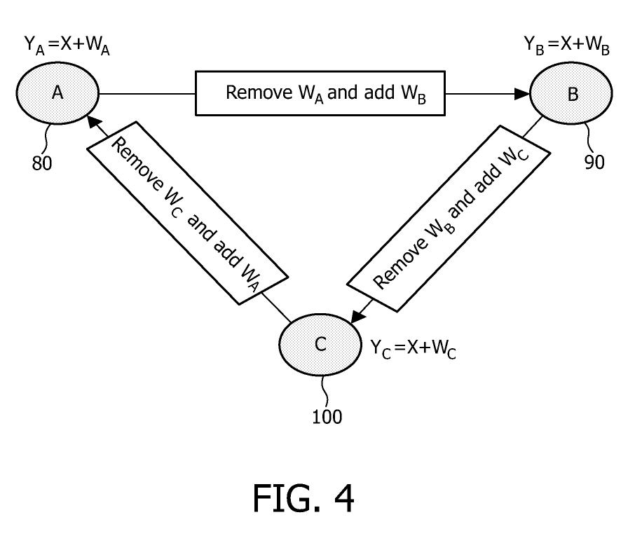

It will be appreciated that the present invention can be implemented using any number of different entities. For example, whilst the above implementations have been described with respect to peer A sharing digital content with peer B, peer B could equally then share digital content with another, different entity e.g. peer C (as indicated in FIG. 4). The present invention can therefore be used to share digital content between any number of different peers A, B, C (80, 90, 100), using one or more TTP's.

As described herein, the method allows the removal of a forensic watermark (e.g. W_{A}, W_{B}, W_{C}) and the application of a different forensic watermark, whilst ensuring that whilst transmitted the digital content is encrypted (preferably using a one time pad). The technique thereby allows the sharing of digital content, whilst ensuring that the quality of the digital content does not automatically degrade, and allowing any desired number of forensic watermarks to be successively embedded (due to the removal of the previous forensic watermark at each embedding step). Thus the method provides a secure technique for peer to peer file sharing.

1. A method of transferring digital content from a first entity to a second entity, comprising the steps of:
a transfer control entity transmitting a transmission key to a first entity, the first entity storing content data comprising digital content embedded with a first watermark;
the first entity applying the transmission key to the content data to remove the first watermark from the digital content and encrypt the digital content;
the first entity transmitting the encrypted digital content to a second entity;
the transfer control entity transmitting a receive key to the second entity; and
the second entity applying the receive key to the encrypted digital content to generate decrypted data comprising the decrypted digital content embedded with a second watermark.

2. A method as claimed in claim 1, further comprising the step of performing an authenticity check of the encrypted digital content, to determine whether the digital content has been modified.

3. A method as claimed in claim 1, further comprising the step of the second entity transmitting a payment to the transfer control entity.

4. A method as claimed in claim 1, further comprising the step of the transfer control entity transmitting a payment to the first entity.

5. A method as claimed in claim 1, comprising:
the transfer control entity transmitting a plurality of transmission keys to the first entity;
the first entity storing said plurality of transmission keys in a memory; and
the first entity selecting one of said stored transmission keys to apply to said content data to remove said first watermark from the digital content and encrypt the digital content.

6. A method as claimed in claim 5, wherein said step of selecting one of said transmission keys is a random selection, the method further comprising:
the first entity transmitting identification data indicative of the identify of the selected key to at least one of the second entity and the transfer control entity.

7. A method as claimed in claim 5, further comprising:
the transfer control entity transmitting selection data to said first entity; and
the first entity selecting said one of said stored transmission keys based upon the selection data.

8. A method as claimed in claim 1, comprising:
the transfer control entity transmitting a plurality of receive keys to the second entity;
the second entity storing said plurality of receive keys in a memory; and
the second entity selecting one of said stored receive keys, to apply to the encrypted digital content to generate the decrypted data comprising the decrypted digital content embedded with the second watermark, based upon identification data received from at least one of the transfer control entity and the first entity.

9. A method of transmitting digital content, comprising the steps of:
a first entity receiving a transmission key from a transfer control entity, the first entity storing content data comprising digital content embedded with a first watermark;
the first entity applying the transmission key to the content data to remove the first watermark from the digital content and encrypt the digital content; and
the first entity transmitting the encrypted digital content to a second entity.

10. A method as claimed in claim 9, wherein said transmission key is arranged to simultaneously remove the watermark and encrypt the digital content, when applied to said content data.

11. A method of receiving digital content, comprising the steps of:
a second entity receiving encrypted digital content from a first entity;
the second entity receiving a receive key from a transfer control entity; and
the second entity applying the receive key to the encrypted digital content to generate decrypted data comprising the decrypted digital content embedded with a second watermark.

12. A method as claimed in claim 11, wherein said receive key is arranged to simultaneously decrypt the encrypted digital content and embed the second watermark in said digital content, when applied to the encrypted digital content.

13. A method for controlling the transfer of digital content, comprising the steps of:
a transfer control entity transmitting a transmission key to a first entity, the transmission key being for application to content data comprising digital content embedded with a first watermark, for removing the first watermark from the digital content and encrypting the digital content.

14. A method as claimed in claim 13, further comprising the steps of:
the transfer control entity storing information indicative of the first watermark in a memory; and
the transfer control entity generating the transmission key using said stored information.

15. A method as claimed in claim 1, wherein the encrypted digital content is encrypted by a mask.

16. A method as claimed in claim 1, wherein said encrypted digital content is encrypted using random noise.

17. A method as claimed in claim 1, wherein said encrypted digital content is encrypted using a one time pad.

18-20. (canceled)

21. A transmission key for application to content data comprising digital content embedded with a first watermark, the transmission key being arranged to remove the first watermark and encrypt the digital content when applied to the content data.

22. A transmission key as claimed in claim 21, wherein said key is arranged to simultaneously remove the watermark and encrypt the digital content, when applied to said content data.

23. A carrier medium storing said transmission key of claim 21 in computer readable code.
